(19) United States
(12) Patent Application Publication
(10) Pub. No.: US 2020/0193400 A1
(43) Pub. Date: Jun. 18, 2020

(54) MANAGING COMMUNICATIONS

(71) Applicant: Galileo Processing, Inc., Salt Lake City, UT (US)

(72) Inventor: Thomas Clay Wilkes, North Salt Lake, UT (US)

(21) Appl. No.: 16/719,632

(22) Filed: Dec. 18, 2019

Related U.S. Application Data
(60) Provisional application No. 62/781,478, filed on Dec. 18, 2018.

(51) Int. Cl. G06Q 20/12; G06Q 40/02; G06Q 20/10; G06Q 40/06; G06Q 40/04; G06Q 20/40

(52) U.S. Cl. CPC G06Q 20/127; G06Q 40/02; G06Q 20/4037; G06Q 40/06; G06Q 40/04; G06Q 20/108

(57) ABSTRACT

A method may include receiving an approval request from a payment system including a purchase amount of the transaction and a time limit. The method may include obtaining a current value of securities. The method may include determining a purchase amount limit based on the current value. Responsive to the purchase amount being less than or equal to the purchase amount limit, the method may include obtaining margin loan funds equal to the purchase amount. The method may include sending the margin loan funds to the payment system. The payment system may approve the financial transaction prior to the time limit expiring responsive to receiving the margin loan funds. The method may include instructing the record keeper to have a broker sell at least a portion of the securities to attain sale funds. The method may include obtaining the sale funds and settling the margin loan using the sale funds.

### CROSS-REFERENCE TO RELATED APPLICATION

This patent application claims the benefit of and priority to U.S. Provisional App. No. 62/781,478 filed Dec. 18, 2018 titled “MANAGING COMMUNICATIONS,” which is incorporated in the present disclosure by reference in its entirety.

### FIELD

The embodiments discussed in the present disclosure are related to managing communications.

### BACKGROUND

When processing and funding a transaction using a financial card linked to securities, data related to the securities, loans, and/or other integral aspects of the transaction may be transferred between multiple entities. To permit this data to be transferred in a manner that permits transactions to be processed and funded in real time, management of communication between the multiple entities may occur.

The subject matter claimed in the present disclosure is not limited to embodiments that solve any disadvantages or that operate only in environments such as those described above. Rather, this background is only provided to illustrate one example technology area where some embodiments described in the present disclosure may be practiced.

### SUMMARY

One or more embodiments of the present disclosure may include a method. The method may include receiving an approval request for a financial transaction. The approval request may be received from a payment system. The approval request may include a purchase amount corresponding to the financial transaction. Also, the approval request may include a time limit. The time limit may indicate an amount of time before the approval request times out and is void. The method may also include obtaining information indicating a current value of securities associated with a financial card from a record keeper system. The record keeper system may be associated with the securities. In addition, the method may include determining a purchase amount limit. The purchase amount limit may be determined based on the current value. The purchase amount limit may include a percentage of the current value. Responsive to the purchase amount being less than or equal to the purchase amount, the method may include obtaining margin loan funds equal to the purchase amount. The margin loan funds may be obtained based on a margin loan attributed to a user that initiated the financial transaction. Responsive to the purchase amount being less than or equal to the purchase amount limit, the method may include obtaining margin loan funds equal to the purchase amount, the method may also include sending the margin loan funds to the payment system. The payment system may approve the financial transaction prior to the time limit expiring responsive to receiving the margin loan funds. In addition, responsive to the purchase amount being less than or equal to the purchase amount, the method may include instructing the record keeper system to have a broker system sell at least a portion of the securities to attain sale funds. Further, responsive to the purchase amount being less than or equal to the purchase amount, the method may include obtaining the sale funds. The method may also include settling the margin loan using the sale funds.

One or more embodiments of the present disclosure may include a transaction processing system. The system may include a processor. The processor may be configured to cause performance of operations. The operations may include receiving an approval request for a financial transaction from a payment system. The approval request may include a purchase amount corresponding to the financial transaction. Also, the approval request may include a time limit. The time limit may indicate an amount of time before the approval request times out and is void. The operations may also include obtaining information indicating a current value of securities associated with a financial card from a record keeper system associated with the securities. In addition, the operations may include determining a purchase amount limit based on the current value. The purchase amount limit may include a percentage of the current value. Further, responsive to the purchase amount being less than or equal to the purchase amount limit, the operations may include obtaining margin loan funds equal to the purchase amount. The margin loan funds may be obtained based on a margin loan attributed to a user that initiated the financial transaction. Responsive to the purchase amount being less than or equal to the purchase amount, the operations may include sending the margin loan funds to the payment system. The payment system may approve the financial transaction prior to the time limit expiring responsive to receiving the margin loan funds. Responsive to the purchase amount being less than or equal to the purchase amount, the operations may also include instructing the record keeper system to have a broker sell at least a portion of the securities to attain sale funds. In addition, responsive to the purchase amount being less than or equal to the purchase amount, the operations may include obtaining the sale funds. The operations may also include settling the margin loan using the sale funds.

One or more embodiments of the present disclosure may include a non-transitory computer-readable media storing one or more programs that are configured, when executed, to cause a system to operate according to operations. The operations may include receiving an approval request for a financial transaction from a payment system. The approval request may include a purchase amount corresponding to the financial transaction. Also, the approval request may include a time limit. The time limit may indicate an amount of time before the approval request times out and is void. The operations may also include obtaining information indicating a current value of securities associated with a financial card from a record keeper system associated with the securities. In addition, the operations may include determining a purchase amount limit based on the current value. The purchase amount limit may include a percentage of the current value. Further, responsive to the purchase amount being less than or equal to the purchase amount limit, the operations may include obtaining margin loan funds equal to the purchase amount. The margin loan funds may be obtained based on a margin loan attributed to a user that initiated the financial transaction. Responsive to the purchase amount being less than or equal to the purchase amount, the operations may include sending the margin loan funds to the payment system. The payment system may approve the financial transaction prior to the time limit expiring responsive to receiving the margin loan funds. Responsive to the purchase amount being less than or equal to the purchase amount, the operations may also include instructing the record keeper system to have a broker system sell at least a portion of the securities to attain sale funds. In addition, responsive to the purchase amount being less than or equal to the purchase amount, the operations may include obtaining the sale funds. The operations may also include settling the margin loan using the sale funds.

The object and advantages of the embodiments will be realized and achieved at least by the elements, features, and combinations particularly pointed out in the claims. Both the foregoing general description and the following detailed description are exemplary and explanatory and are not restrictive.

### BRIEF DESCRIPTION OF THE DRAWINGS

Example embodiments will be described and explained with additional specificity and detail through the use of the accompanying drawings in which:

FIG. 1 illustrates an example operating environment related to funding a financial transaction that uses a financial card linked to securities;

FIG. 2 illustrates a flowchart of an example method of funding a financial transaction that uses a financial card linked to securities;

FIG. 3 illustrates a block diagram of an example computing system, all according to at least one embodiment described in the present disclosure.

### DETAILED DESCRIPTION

A user of a financial card that is linked to one or more securities may initiate a transaction with a merchant system. The financial transaction may be for a purchase of goods or services from the merchant system. The financial transaction may occur in a retail store, online, or any other appropriate location. In some embodiments, the securities may include financial instruments that are worth a current value. For example, the securities may include stocks, bonds, 401k accounts, ROTH individual retirement accounts (ROTH IRAs), or any other appropriate financial instrument or combination of financial instruments. As used in the present disclosure, the term “current value” may refer to a quantity of funds that may be obtained through a sale or other form of transferal of ownership of the securities. The financial transaction may be initiated and performed using the financial card.

The financial transaction may be for a purchase amount that indicates a quantity of funds being requested to be transferred to the merchant system. As used in the present disclosure, the term “amount” may generally refer to a quantity of money being requested or authorized for the financial transaction. Likewise, as used in the present disclosure, the term “funds” may refer to a specific quantity of money.

Securities may include complex financial instruments that may be difficult to sell in real time to permit the financial transaction to be funded. As used in the present disclosure, the term “real time” may generally refer to a period of time that doesn't cause the financial transaction to time out or cause unusual delays at the merchant system. Accordingly, in some embodiments described in the present disclosure, communications may occur between the merchant system, a payment system, a bank system, a broker dealer system, a record keeper system, and a financial institution system to obtain margin loan funds to fund the financial transaction prior to a time limit expiring and sale funds to settle a margin loan associated with the margin loan funds.

In some embodiments, an approval request for the financial transaction may be received from the payment system. The approval request may include the time limit. The time limit may indicate an amount of time before the approval request times out and is void. In these and other embodiments, information indicating the current value of the securities may be obtained from the record keeper system. The record keeper system may be associated with the securities. A purchase amount limit may be determined. The purchase amount limit may be based on the current value of the securities.

In some embodiments, responsive to the purchase amount being less than or equal to the purchase amount limit, the margin loan funds may be obtained. The margin loan funds may be equal to the purchase amount. In these and other embodiments, the margin loan funds may be obtained based on the margin loan. The margin loan may be attributed to the user that initiated the financial transaction. The margin loan funds may be sent to the payment system. Responsive to receiving the margin loan funds, the payment system may approve the financial transaction prior to the time limit expiring. To settle the margin loan, the record keeper system may be instructed to have the broker dealer system sell at least a portion of the securities. The securities may be sold to attain the sale funds to settle the margin loan. In some embodiments, the margin loan may be settled after the time limit expires. In other embodiments, the margin loan may be settled before the time limit expires.

Some of the embodiments described in the present disclosure may permit communication between the merchant system, the payment system, the financial institution system, the bank system, the record keeper system, and the broker dealer system to occur quick enough to fund the financial transaction in real time (e.g., prior to the time limit expiring). In addition, some of the embodiments described in the present disclosure may permit financial transactions to be funded using securities that were previously unable to be funded using securities.

These and other embodiments of the present disclosure will be explained with reference to the accompanying figures. It is to be understood that the figures are diagrammatic and schematic representations of such example embodiments, and are not limiting, nor are they necessarily drawn to scale. In the figures, features with like numbers indicate like structure and function unless described otherwise.

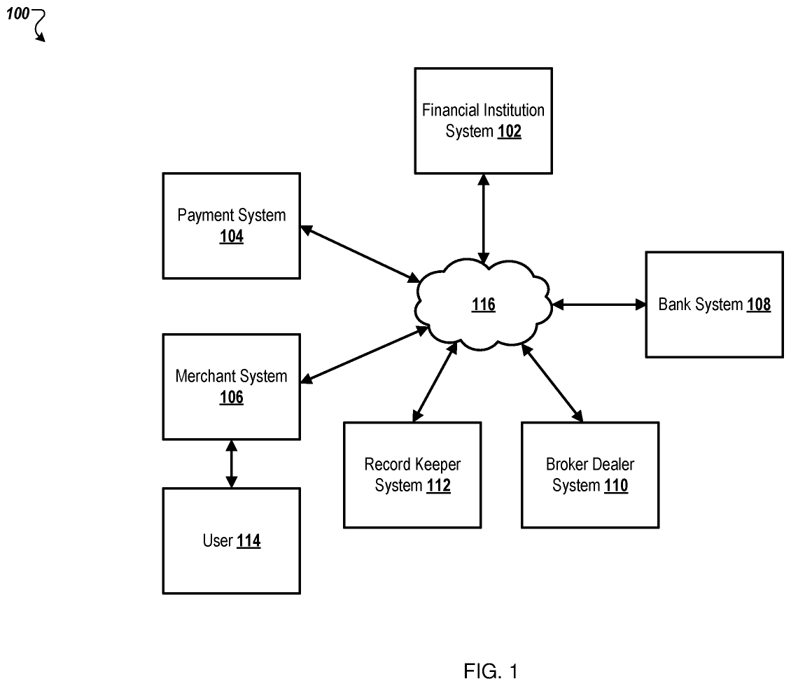

FIG. 1 illustrates an example operating environment 100 related to funding a financial transaction that uses the financial card linked to securities. The operating environment 100 may include a financial institution system 102, a payment system 104, a merchant system 106, a bank system 108, a broker dealer system 110, a record keeper system 112, a user 114, and a network 116.

The network 116 may include any communication network configured for communication of signals between any of the components (e.g., 102, 104, 106, 108, 110, and 112) of the operating environment 100. The network 116 may be wired or wireless. The network 116 may have numerous configurations including a star configuration, a token ring configuration, or another suitable configuration. Furthermore, the network 116 may include a local area network (LAN), a wide area network (WAN) (e.g., the Internet), and/or other interconnected data paths across which multiple devices may communicate. In some embodiments, the network 116 may include a peer-to-peer network. The network 116 may also be coupled to or include portions of a telecommunications network that may enable communication of data in a variety of different communication protocols.

In some embodiments, the network 116 includes or is configured to include a BLUETOOTH® communication network, a Z-Wave® communication network, an Insteon® communication network, an EnOcean® communication network, a Wi-Fi communication network, a ZigBee communication network, a HomePlug communication network, a Power-line Communication (PLC) communication network, a message queue telemetry transport (MQTT) communication network, a MQTT-sensor (MQTT-S) communication network, a constrained application protocol (CoAP) communication network, a representative state transfer application protocol interface (REST API) communication network, an extensible messaging and presence protocol (XMPP) communication network, a cellular communication network, any similar communication networks, or any combination thereof for sending and receiving data. The data communicated in the network 116 may include data communicated via short messaging service (SMS), multimedia messaging service (MMS), hypertext transfer protocol (HTTP), direct data connection, wireless application protocol (WAP), e-mail, smart energy profile (SEP), ECHONET Lite, OpenADR, or any other protocol that may be implemented with the financial institution system 102, the payment system 104, the merchant system 106, the bank system 108, the broker dealer system 110, and the record keeper system 112.

In some embodiments, the user 114 may initiate the financial transaction for the purchase amount with the merchant system 106 using the financial card. The merchant system 106 may run the financial card to obtain approval of the financial transaction. For example, the merchant system 106 may request that the user 114 swipe the financial card through a card reader (e.g., scan the financial card). As another example, the merchant system 106 may request that the user 114 provide a card number and/or a personal identification number (PIN) associated with the financial card.

The merchant system 106 may send a transaction request to the payment system 104. The payment system 104 may include an entity that issued or maintains support of the financial card. For example, the payment system 104 may include MasterCard, Visa, American Express, Discover, Chase Bank, Wells Fargo, Bank of America, or any other appropriate entity.

In some embodiments, the payment system 104 may identify the securities linked to the financial card based on a type of the financial card. In these and other embodiments, the payment system 104 may also identify the financial institution system 102 based on the securities linked to the financial card. For example, the payment system 104 may identify the securities and use a look up table to determine that the financial institution system 102 is associated with the particular securities. The payment system 104 may send an approval request to the financial institution system 102 requesting approval of the financial transaction. Additionally, the approval request may request funds to cover the purchase amount of the financial transaction.

The financial institution system 102 may receive the approval request from the payment system 104. In some embodiments, the approval request may include information identifying the securities linked to the financial card, information identifying the record keeper system 112 as being associated with the securities, and/or information identifying the broker dealer system 110 as being associated with the record keeper system 112 and/or the securities. In addition, in some embodiments, the approval request may include a time limit. In these and other embodiments, the time limit may indicate an amount of time before the approval request times out and is void. The amount of time may be indicated as a timer (e.g., ten minutes) or a specific time (e.g., 4:00PM). The time limit may expire if the timer or the specific time elapses. For example, if the time limit is ten minutes, the time limit may expire after ten minutes since the approval request was sent. As another example, if the time limit indicates 4:00PM, the time limit may expire when the time reaches 4:00PM.

In some embodiments, if not included in the approval request, the financial institution system 102 may determine the securities linked to the financial card. In these and other embodiments, if not included in the approval request, the financial institution system 102 may identify the record keeper system 112 and/or the broker dealer system 110 as being associated with the securities. Additionally or alternatively, the financial institution system 102 may identify the broker dealer system 110 as being associated with the record keeper system 112 and not directly associated with the securities. Furthermore, in some embodiments, the financial institution system 102 may identify the bank system 108 as being an entity that has agreed to issue margin loans for transactions being performed using financial cards linked to securities. The financial institution system 102 may send a current value request to the record keeper system 112. The current value request may indicate that the financial institution system 102 is seeking information indicating the current value of the securities.

The record keeper system 112 may receive the current value request. Additionally, the record keeper system 112 may determine the current value of the securities. The current value may be based on a running average of the securities over a period of time, an up to the minute valuation of the securities, or any other appropriate process for determining the current value. The record keeper system 112 may provide a response message that includes the information indicating the current value to the financial institution system 102.

The financial institution system 102 may determine the purchase amount limit based on the current value. The purchase amount limit may be a maximum amount of funds that the purchase amount may be that permits the financial transaction to be approved. In some embodiments, the purchase amount limit may be a percentage of the current value. The purchase amount limit may be a percentage of the current value to account for fluctuations of the current value based on changes in associated markets, costs associated with selling the securities, or interest and other charges associated with processing; maintaining; and settling the margin loan. In some embodiments, the purchase amount limit may be between sixty and ninety percent of the current value. In other embodiments, the purchase amount limit may be equal to the current value.

The financial institution system 102 may determine whether the purchase amount is equal to or less than the purchase amount limit. If the purchase amount is less than or equal to the purchase amount limit, the financial institution system 102 may request the margin loan from the bank system 108 (e.g., an external bank). Alternatively, the financial institution system 102 may request the margin loan internally (e.g., an internal bank). The financial institution system 102 may request the margin loan due to obtaining margin loan funds being faster than obtaining sale funds. This may be due to the fact that obtaining the margin loan funds does not include selling the securities. The margin loan may be for an amount of funds equal to the purchase amount (e.g., the margin loan funds may be equal to the purchase amount).

In some embodiments, the bank system 108 may issue the margin loan and provide the margin loan funds to the financial institution system 102. In other embodiments, the financial institution system 102 may issue the margin loan. In some embodiments, the margin loan may be attributed to the user 114 (e.g., the user 114 may be financially liable for repaying the margin loan funds). Attributing the financial burden of the margin loan to the user 114 may reduce an occurrence of the user 114 fraudulently using the financial card.

The financial institution system 102 may verify that the margin loan funds are sufficient to cover the purchase amount. If the margin loan funds are insufficient, the financial institution system 102 may interact with the bank system 108 to correct the shortage and obtain sufficient margin loan funds. If the margin loan funds are sufficient, the financial institution system 102 may provide the margin loan funds to the payment system 104 to cover the purchase amount.

The payment system 104 may also verify that the margin loan funds are sufficient to cover the purchase amount and may approve the financial transaction if sufficient. The payment system 104 may provide an approved message to the merchant system 106 responsive to receiving the margin loan funds from the financial institution system 102. The payment system 104 may provide the approved message (e.g., may approve the financial transaction) prior to the time limit expiring. The merchant system 106 may complete the financial transaction with the user 114 and may provide the goods or services being sought to the user 114.

In addition, in some embodiments, the financial institution system 102 may instruct the record keeper system 112 to have the broker dealer system 110 sell at least a portion of the securities. The securities may be sold until the sale funds equal to the purchase amount are attained. Additionally or alternatively, the securities may be sold until sale funds equal to an amount to settle the margin loan are attained. In some embodiments, the broker dealer system 110 may provide the sale funds to the record keeper system 112. In these and other embodiments, the record keeper system 112 may provide the sale funds to the financial institution system 102. In other embodiments, the broker dealer system 110 may provide the sale funds directly to the financial institution system 102.

In some embodiments, the financial institution system 102 may instruct the record keeper system 112 to sell at least portion of the securities until the sale funds are attained. In these and other embodiments, if not included in the approval request or already indicated by the financial institution system 102, the record keeper system 112 may determine that the broker dealer system 110 is associated with or otherwise approved to sell the securities.

The financial institution system 102 may receive the sale funds from the record keeper system 112 or the broker dealer system 110. Additionally, the financial institution system 102 may settle the margin loan using the sale funds. In some embodiments, the financial institution system 102 may provide the sale funds to the bank system 108 to settle the margin loan. In other embodiments, the broker dealer system 110 or the record keeper system 112 may provide the sale funds directly to the bank system 108 to settle the margin loan. Alternatively, the financial institution system 102, in embodiments in which the margin loan was issued within the financial institution system 102, may settle the margin loan internally. In some embodiments, the margin loan may be settled after the time limit expires. In other embodiments, the margin loan may be settled before the time limit expires.

If the purchase amount is greater than the purchase amount limit, the financial institution system 102 may notify the payment system 104 that the purchase amount exceeds the purchase amount limit. The payment system 104 may deny the financial transaction and may send a denied message to the merchant system 106 indicating such. The merchant system 106 may reject the financial transaction and return the financial card to the user 114. The merchant system 106 may maintain ownership of the goods or not provide the services being sought by the user 114.

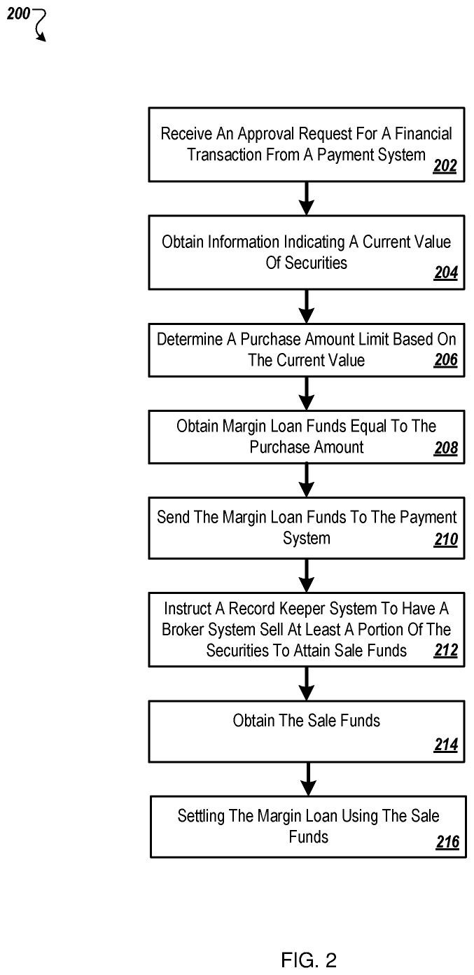

FIG. 2 illustrates a flowchart of an example method 200 of funding the financial transaction that uses the financial card linked to securities, in accordance with at least one embodiment disclosed herein. Method 200 may be performed by any suitable system, apparatus, or device with respect to funding the financial transaction that uses the financial card linked to securities. For example, the financial institution system 102, the payment system 104, the merchant system 106, the bank system 108, the broker dealer system 110, and the record keeper system 112 of FIG. 1 may perform or direct performance of one or more of the operations associated with the method 200 with respect to funding the financial transaction that uses the financial card linked to securities. Although illustrated with discrete blocks, the steps and operations associated with one or more of the blocks of the method 200 may be divided into additional blocks, combined into fewer blocks, or eliminated, depending on the particular implementation.

The method 200 may include a block 202, at which the approval request for the financial transaction from the payment system may be received. In some embodiments, the approval request may include the purchase amount corresponding to the financial transaction. In these and other embodiments, the approval request may include a time limit indicating an amount of time before the approval request times out and is void. For example, the approval request for the financial transaction from may be received from the payment system 104 of FIG. 1. At block 204, information indicating the current value of the securities may be obtained. In some embodiments, the information indicating the current value of the securities may be obtained from the record keeper system associated with the securities. In these and other embodiments, the securities may be associated with a financial card. For example, the information indicating the current value of the securities from may be obtained from the record keeper system 112 of FIG. 1.

At block 206, the purchase amount limit based on the current value may be determined. In some embodiments, the purchase amount limit may include a percentage of the current value. At block 208, responsive to the purchase amount being less than or equal to the purchase amount, margin loan funds equal to the purchase amount may be obtained. In some embodiments, the margin loan funds may be obtained based on a margin loan attributed to the user that initiated the financial transaction. At block 210, responsive to the purchase amount being less than or equal to the purchase amount, the margin loan funds may be sent to the payment system. In some embodiments, the payment system may approve the financial transaction prior to the time limit expiring responsive to receiving the margin loan funds. For example, the margin loan funds may be sent, and the financial transaction may be approved by the payment system 104 of FIG. 1. At block 212, responsive to the purchase amount being less than or equal to the purchase amount, the record keeper system may be instructed to have a broker system sell at least a portion of the securities to attain sale funds. For example, the record keeper system 112 of FIG. 1 may instruct the broker dealer system 110 of FIG. 1 to sell at least a portion of the securities. At block 214, responsive to the purchase amount being less than or equal to the purchase amount, the sale funds may be obtained. At block 216, responsive to the purchase amount being less than or equal to the purchase amount, the margin loan may be settled using the sale funds.

Alternatively, responsive to the purchase amount being greater than the purchase amount limit, the method 200 may include notifying the payment system that the current value is insufficient. In some embodiments, the payment system may deny the financial transaction based on the current value being insufficient.

Modifications, additions, or omissions may be made to the method 200 without departing from the scope of the present disclosure. For example, the operations of method 200 may be implemented in differing order. Additionally or alternatively, two or more operations may be performed at the same time. Furthermore, the outlined operations and actions are only provided as examples, and some of the operations and actions may be optional, combined into fewer operations and actions, or expanded into additional operations and actions without detracting from the essence of the disclosed embodiments.

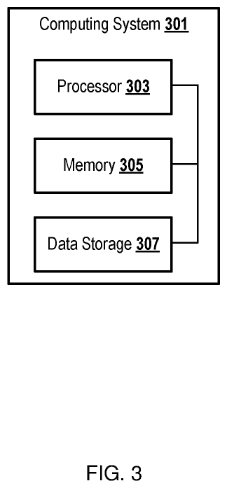

FIG. 3 illustrates a block diagram of an example computing system 301. The computing system 301 may be configured according to at least one embodiment of the present disclosure and may be configured to perform one or more operations related to funding the financial transaction that uses the financial card linked to securities. The computing system 301 may include a processor 303, a memory 305, and a data storage 307. The processor 303, the memory 305, and the data storage 307 may be communicatively coupled.

In general, the processor 303 may include any suitable special-purpose or general-purpose computer, computing entity, or processing device including various computer hardware or software modules and may be configured to execute instructions stored on any applicable computer-readable storage media. For example, the processor 303 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data. Although illustrated as a single processor in FIG. 3, the processor 303 may include any number of processors configured to, individually or collectively, perform or direct performance of any number of operations described in the present disclosure. Additionally, one or more of the processors may be present on one or more different electronic devices, such as different servers.

In some embodiments, the processor 303 may be configured to interpret and/or execute program instructions and/or process data stored in the memory 305, the data storage 307, or the memory 305 and the data storage 307. In some embodiments, the processor 303 may fetch program instructions from the data storage 307 and load the program instructions in the memory 305. After the program instructions are loaded into memory 305, the processor 303 may execute the program instructions.

For example, in some embodiments, operations performed by the financial institution system 102, the payment system 104, the merchant system 106, the bank system 108, the broker dealer system 110, and the record keeper system 112 of FIG. 1 may be included in the data storage 307 as program instructions. The processor 303 may fetch the corresponding program instructions from the data storage 307 and may load the program instructions in the memory 305. After the program instructions of the financial institution system 102, the payment system 104, the merchant system 106, the bank system 108, the broker dealer system 110, and the record keeper system 112 of FIG. 1 are loaded into memory 305, the processor 303 may execute the program instructions such that the computing system 301 may perform or direct the performance of the operations associated with the financial institution system 102, the payment system 104, the merchant system 106, the bank system 108, the broker dealer system 110, and the record keeper system 112 of FIG. 1 as directed by the instructions.

The memory 305 and the data storage 307 may include computer-readable storage media for carrying or having computer-executable instructions or data structures stored thereon. Such computer-readable storage media may include any available media that may be accessed by a general-purpose or special-purpose computer, such as the processor 303. By way of example, and not limitation, such computer-readable storage media may include tangible or non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store particular program code in the form of computer-executable instructions or data structures and which may be accessed by a general-purpose or special-purpose computer. In these and other embodiments, the term “non-transitory” as explained in the present disclosure should be construed to exclude only those types of transitory media that were found to fall outside the scope of patentable subject matter in the Federal Circuit decision of In re Nuuten, 500 F.3d 1346 (Fed. Cir. 2007). Combinations of the above may also be included within the scope of computer-readable media.

Modifications, additions, or omissions may be made to the computing system 301 without departing from the scope of the present disclosure. For example, in some embodiments, the computing system 301 may include any number of other components that may not be explicitly illustrated or described.

Embodiments described in the present disclosure may be implemented using computer-readable media for carrying or having computer-executable instructions or data structures stored thereon. Such computer-readable media may be any available media that may be accessed by a general purpose or special purpose computer. By way of example, and not limitation, such computer-readable media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store desired program code in the form of computer-executable instructions or data structures and which may be accessed by a general purpose or special purpose computer. Combinations of the above may also be included within the scope of computer-readable media.

Computer-executable instructions may include, for example, instructions and data, which cause a general-purpose computer, special purpose computer, or special purpose processing device (e.g., one or more processors) to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in the present disclosure, terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

All examples and conditional language recited in the present disclosure are intended for pedagogical objects to aid the reader in understanding the present disclosure and the concepts contributed by the inventor to furthering the art, and are to be construed as being without limitation to such specifically recited examples and conditions. Although embodiments of the present disclosure have been described in detail, various changes, substitutions, and alterations could be made hereto without departing from the spirit and scope of the present disclosure.

What is claimed is:

1. A method comprising:
receiving an approval request for a financial transaction from a payment system, the approval request including a purchase amount corresponding to the financial transaction and a time limit indicating an amount of time before the approval request times out and is void;
obtaining information indicating a current value of securities associated with a financial card from a record keeper system associated with the securities;
determining a purchase amount limit based on the current value, the purchase amount limit including a percentage of the current value;
responsive to the purchase amount being less than or equal to the purchase amount limit:
obtaining margin loan funds equal to the purchase amount, the margin loan funds being obtained based on a margin loan attributed to a user that initiated the financial transaction;
sending the margin loan funds to the payment system, the payment system approving the financial transaction prior to the time limit expiring responsive to receiving the margin loan funds;
instructing the record keeper system to have a broker sell at least a portion of the securities to attain sale funds;
obtaining the sale funds; and
settling the margin loan using the sale funds.

2. The method of claim 1, wherein responsive to the purchase amount being greater than the purchase amount limit, the method further comprises notifying the payment system that the current value is insufficient, the payment system denying the financial transaction based on the current value being insufficient.

3. The method of claim 1, wherein the margin loan is settled using the sale funds after the time limit expires.

4. The method of claim 1, wherein the record keeper system receives the sale funds from the broker and the sale funds are obtained from the record keeper system.

5. The method of claim 1, wherein the purchase amount limit is a maximum amount of funds that the purchase amount can be that permits the financial transaction to be approved.

6. The method of claim 1 further comprising verifying that the margin loan funds are greater than or equal to the purchase amount.

7. The method of claim 1, wherein the record keeper system is instructed to have the broker sell the at least the portion of the securities until the sale funds equal the purchase amount.

8. A transaction processing system comprising:
a processor configured to cause performance of operations to be performed, the operations comprising:
receiving an approval request for a financial transaction from a payment system, the approval request including a purchase amount corresponding to the financial transaction and a time limit indicating an amount of time before the approval request times out and is void;
obtaining information indicating a current value of securities associated with a financial card from a record keeper system associated with the securities;
determining a purchase amount limit based on the current value, the purchase amount limit including a percentage of the current value;
responsive to the purchase amount being less than or equal to the purchase amount limit:
obtaining margin loan funds equal to the purchase amount, the margin loan funds being obtained based on a margin loan attributed to a user that initiated the financial transaction;
sending the margin loan funds to the payment system, the payment system approving the financial transaction prior to the time limit expiring responsive to receiving the margin loan funds;
instructing the record keeper system to have a broker sell at least a portion of the securities to attain sale funds;
obtaining the sale funds; and
settling the margin loan using the sale funds.

9. The transaction processing system of claim 8, wherein responsive to the purchase amount being greater than the purchase amount limit, the operations further comprise notifying the payment system that the current value is insufficient, the payment system denying the financial transaction based on the current value being insufficient.

10. The transaction processing system of claim 8, wherein the margin loan is settled using the sale funds after the time limit expires.

11. The transaction processing system of claim 8, wherein the record keeper system receives the sale funds from the broker and the sale funds are obtained from the record keeper system.

12. The transaction processing system of claim 8, wherein the purchase amount limit is a maximum amount of funds that the purchase amount can be that permits the financial transaction to be approved.

13. The transaction processing system of claim 8, the operations further comprising verifying that the margin loan funds are greater than or equal to the purchase amount.

14. The transaction processing system of claim 8, wherein the record keeper system is instructed to have the broker sell the at least the portion of the securities until the sale funds equal the purchase amount.

15. A non-transitory computer-readable media storing one or more programs that are configured, when executed, to cause a system to operate according to operations, the operations comprising:
receiving an approval request for a financial transaction from a payment system, the approval request including a purchase amount corresponding to the financial transaction and a time limit indicating an amount of time before the approval request times out and is void;
obtaining information indicating a current value of securities associated with a financial card from a record keeper system associated with the securities;
determining a purchase amount limit based on the current value, the purchase amount limit including a percentage of the current value;
responsive to the purchase amount being less than or equal to the purchase amount limit:
obtaining margin loan funds equal to the purchase amount, the margin loan funds being obtained based on a margin loan attributed to a user that initiated the financial transaction;
sending the margin loan funds to the payment system, the payment system approving the financial transaction prior to the time limit expiring responsive to receiving the margin loan funds;
instructing the record keeper system to have a broker sell at least a portion of the securities to attain sale funds;
obtaining the sale funds; and
settling the margin loan using the sale funds.

16. The non-transitory computer-readable media of claim 15, wherein responsive to the purchase amount being greater than the purchase amount limit, the operations further comprise notifying the payment system that the current value is insufficient, the payment system denying the financial transaction based on the current value being insufficient.

17. The non-transitory computer-readable media of claim 15, wherein the margin loan is settled using the sale funds after the time limit expires.

18. The non-transitory computer-readable media of claim 15, wherein the record keeper system receives the sale funds from the broker and the sale funds are obtained from the record keeper system.

19. The non-transitory computer-readable media of claim 15, wherein the purchase amount limit is a maximum amount of funds that the purchase amount can be that permits the financial transaction to be approved.

20. The non-transitory computer-readable media of claim 15, wherein the record keeper system is instructed to have the broker sell the at least the portion of the securities until the sale funds equal the purchase amount.
